(19) United States
(12) Patent Application Publication
(10) Pub. No.: US 2026/0194971 A1
(43) Pub. Date: Jul. 9, 2026

(54) ELECTRONIC DEVICE AND METHOD FOR DISPLAYING A USER INTERFACE

(71) Applicant: Telefonaktiebolaget LM Ericsson (publ), Stockholm (SE)

(72) Inventor: Andreas KRISTENSSON, SÖDRA SANDBY (SE)

(21) Appl. No.: 18/868,741

(22) PCT Filed: Jun. 17, 2022
(86) PCT No.: PCT/EP2022/066598

§ 371 Date: Nov. 23, 2024

(51) Int. Cl. G06F 3/01; G06F 3/04842; G06F 9/451

(52) U.S. Cl. CPC G06F 3/013; G06F 3/04842; G06F 9/453

(57) ABSTRACT

The present solution is about and electronic device comprising a display for displaying a user interface, an imaging device for determining an area of focus of a user gaze on the display, a position sensing circuitry for determining the position of a pointing device on or above the user interface displayed and a processing unit. Moreover, the processing unit comprises computation circuitry configured to compare the position of the pointing device on or above an element of the user interface with the area of focus of the user gaze determined by the imaging device. The processing unit is then configured to instruct the display to show an event associated with the element when the position of the pointing device determined falls within the area of focus of the user gaze. The present solution is also about a method for showing an event on a display for a user interface when the position of the pointing device detected falls within the area of focus of the user gaze.

### TECHNICAL FIELD

The present solution is about an electronic device for displaying a user interface and in particular an electronic device for showing an event on a user interface. Moreover, the present solution is about a method for showing an event on a user interface, a computer program product comprising instruction sets for performing the method and a computer readable medium storing the computer program product.

### BACKGROUND

In the area of graphical user interfaces (GUIs) and user interfaces in general ever since they were conceived, was to make them more user-friendly and self-explanatory. It started with menu bars replacing or enhancing simple text-based interfaces and developed to icons or pictograms taking the place of pure text. With the advent of pictograms, icons and images came the need to provide an explanation of what the pictograms, icons and images stood for and thus the need for explanatory text arose which was implemented. Also, after the advent of the World Wide Web (WWW) there arose a need to offer the user the possibility to see the entire hyperlink address when hovering with a mouse pointer on or near it. These events associated with a user interface element may also be called tooltips, info tips or hints. Tooltips can be defined as GUI elements which appear over or near screen elements, such as images, text, hyperlinked text, videos, or any other screen element, in the form of a textbox with information about the screen element when the user using his or her pointing device, such as a mouse, pen or finger, hovers over the screen element.

Use of tooltips is now commonplace and very frequently used in GUIs on computer screens, mobile phone screens and also in XR (AR, VR, and mixed reality) environments in any situation where an additional explanation would make sense, since they have the additional advantage of saving space on the screen or in the XR environment, making it less cluttered and appearing only when needed.

However, even the tooltips themselves, although making the GUI more user-friendly, can become distracting to the user, especially when the GUI has many screen elements which potentially could take away the focus of the user from the parts of the GUI, he or she is actually interested in.

Likewise, the problem of user distraction becomes even more pronounced when dealing with elements on a user interface (graphical or not) which are a mixture of different types of content. The user, when scrolling through such a page containing, e.g. hyperlinks, images, animated emojis, video clips and the like will more often than not be distracted from the activity he or she is presently pursuing, since the event associated with these elements (besides displaying a tooltip) may be playing a short version of the video clip or the entire video clip with or without sound. Similar problems may occur in a mixed reality (XR) environment.

Existing solutions either reduce the time the event is shown or offer the option to switch off the showing of these events altogether.

Similar solutions are available in the XR GUI scenarios.

Despite these existing solutions there is a need to provide an improved and even more user-friendly way of displaying events in GUI interfaces, whether they are displayed on a computer screen, a mobile phone, a tablet or in a mixed reality environment, such as XR.

### SUMMARY

The present solution addresses at least some of the problems associated with previous solutions, by providing an electronic device according to claim 1.

According to a first aspect of the present solution, the electronic device comprises a display for displaying a user interface, an imaging device for determining an area of focus of a user gaze on the display, a position sensing circuitry for determining the position of a pointing device on or above the user interface displayed and a processing unit. Moreover, the processing unit comprises computation circuitry configured to compare the position of the pointing device on or above an element of the user interface with the area of focus of the user gaze determined by the imaging device. The processing unit is then configured to instruct the display to show an event associated with the element when the position of the pointing device determined falls within the area of focus of the user gaze.

According to second aspect, the present solution is a method for showing an event on a display for a user interface, where the method comprises
determining the position of a pointing device on or above the display;
determining an area of focus of a user gaze on the display;
comparing the position of the pointing device with the area of focus of the user gaze and displaying an event associated with an element of the user interface displayed when the position of the pointing device detected falls within the area of focus of the user gaze.

According to a third aspect, the present solution is a computer program product comprising computer program code for performing the method mentioned in the previous paragraph, when said computer program code is executed by a programmable processing unit of the electronic device mentioned in an earlier paragraph in this summary section.

One advantage of the present solution is that the user will only see events that he or she is interested in where the interest is gauged dependent on whether the area of the GUI towards which the user gaze is directed overlaps with the area the pointing device. Thus, if the pointing device is not in the user gaze on the GUI, no events will be displayed, and the user will not be distracted by tooltip information, animations or video clips. This works both on GUIs on computer displays, mobile phones and tablet displays as well as in VR, MR, and AR (so called XR) environments.

This will noticeably reduce unnecessary information on the GUI, especially if the GUI contains several screen elements, where some or all of them have an event associated with them.

### BRIEF DESCRIPTION OF THE DRAWINGS

FIG. 1 depicts a common situation when using a web browser with a GUI on a computer

FIG. 2A depicts a first embodiment of an electronic device according to the present solution in a first mode.

FIG. 2B depicts a first embodiment of an electronic device according to the present solution in a second mode

FIG. 3A depicts a second embodiment of an electronic device according to the present solution in a first mode.

FIG. 3B depicts a second embodiment of an electronic device according to the present solution in a second mode

FIG. 4A depicts a third embodiment of an electronic device according to the present solution in a first mode.

FIG. 4B depicts a third embodiment of an electronic device according to the present solution in a second mode.

FIG. 5 depicts an embodiment of a method according to the present solution.

FIG. 6 depicts an electronic device with components performing the steps of the method according to the present solution-to be discussed whether this is needed

FIG. 7 depicts a computer-readable medium storing a computer program executing the method according to the present solution-to be discussed whether this is needed

### DETAILED DESCRIPTION

Before starting with a detailed description of example embodiments of the present solution, it should be emphasized that the example embodiments are for illustration purposes only and should not be taken as limitations to the present solution. A skilled person after having studied the present detailed description would be able to come up with additional embodiments not necessarily explicitly mentioned in the detailed description, but still falling under the terms of the appended claims.

The term “comprising” is to be interpreted as including the features immediately following the term, but not excluding the presence of other features not mentioned after the term. Likewise, the term “comprising” in terms of describing method steps used to perform an embodiment of a method according to the present solution, should be interpreted as including the method steps mentioned after the term, but not excluding the presence of possible other method steps not mentioned after the term.

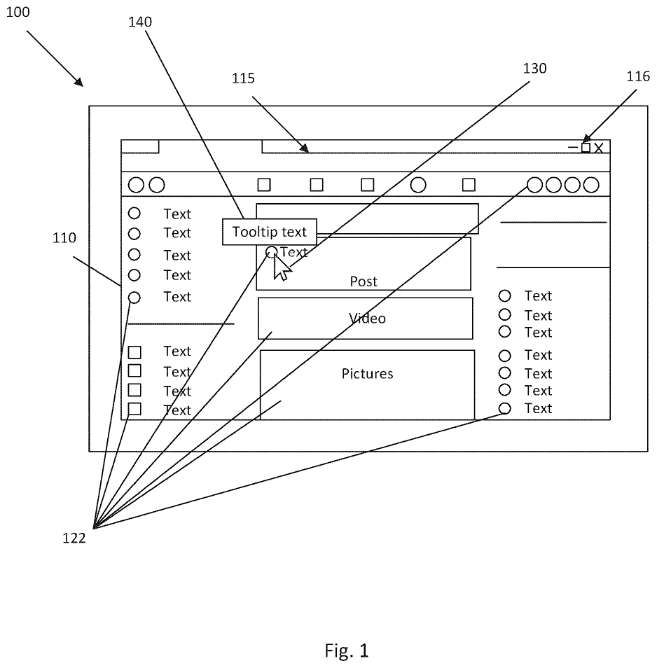

FIG. 1 depicts a common situation where a user (not shown) is browsing the Internet on a display 100 on which a GUI 110 is shown. The GUI 110 in this example comprises one or more windows of which one window 115 is shown in FIG. 1

As is known to the skilled person, the window comprises control elements 116 for minimizing, maximizing, and closing the window in the GUI. In this example, which will be used throughout the description, the user is on an Internet web page 120 belonging to a social media site and comprises a plurality of screen elements 122 many of which when pointed at with a mouse pointer 130 or when passing with a mouse pointer 130 over them will show an event 140 in the form of tooltip information which is usually an explanatory text explaining the function of the screen element 122 pointed at and which in some cases may also include an image. In some cases, when pointing at a screen element 122 related to a video clip with a mouse pointer 130, the event 140 associated with that screen element 122 will be that the video clip will start playing either an abbreviated version of the video clip or the entire video clip and usually with the audio turned off. In some cases even the audio part of the video clip will be played. In prior art solutions, the event 140 will usually be shown regardless of whether the user is interested in it or not, since it appears whenever the mouse pointer 130 is pointing at the screen element 122 or hovering over or near it. Hence accidental pointing at screen elements 122 will result in the same action, i.e., showing an event 140 in the form of tooltip information or playing of a video clip, as if the user was intentionally pointing with the mouse pointer 130 at the screen element 122.

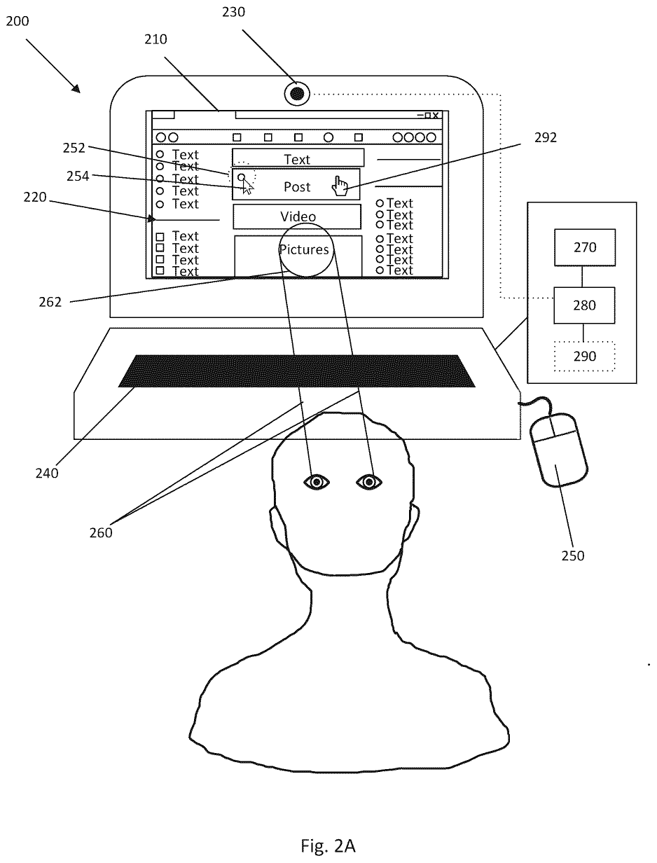

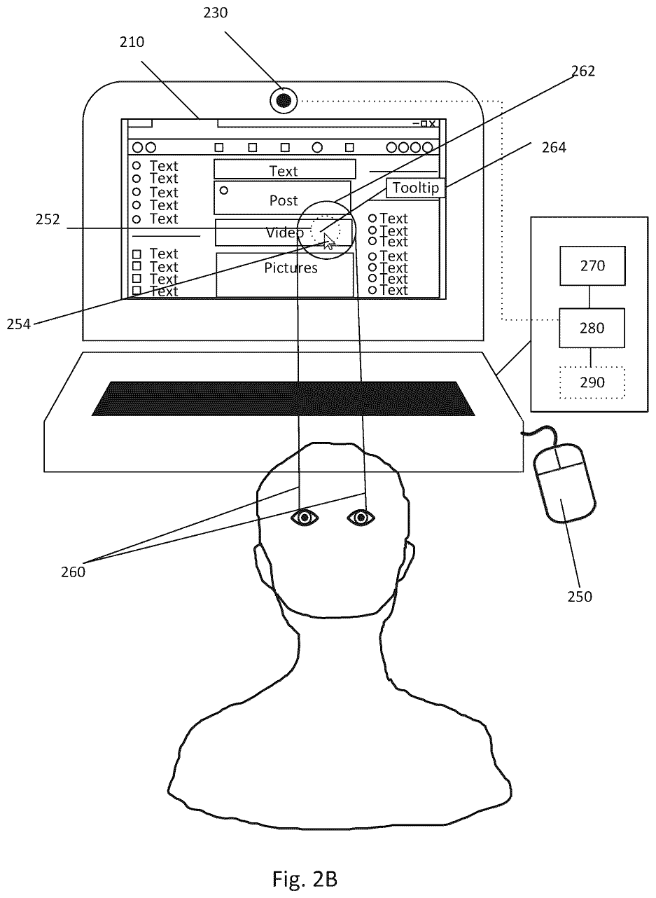

FIG. 2A displays one embodiment of an electronic device according to the present solution in a first situation. A portable computer 200 is equipped with a display 210 on which, for example, a GUI 220 may be shown, an imaging device 230 in the form of a camera for registering the direction and position of the user gaze 260 on the display 210, a keyboard 240 for user input to the GUI 220 on the display 210 and a pointing device 250 in the form of a mouse for being able to select and interact with different screen elements 222 of the GUI shown by means of a mouse pointer 252.

The situation illustrated in FIG. 2A corresponds to the case when the user gaze 260 is focused on a specific area of the GUI 220 illustrated by the solid circle 262 which we from now will call gaze focus area 262. The size and position of the gaze focus area 262 is determined by the imaging device 220 which tracks the angular position of the eyes and the user gaze direction onto the screen in order to calculate the size and location of the gaze focus area 262. How this is done in detail is known in the art and will not be elaborated further. It suffices to state that the gaze tracking of a user gaze 260 on display 210 and the GUI 220 may be performed by an imaging device, which may a single or a pair of cameras or more than two cameras. The imaging device 220 in FIG. 2A is meant to cover these different scenarios.

Now, the mouse pointer 252 is placed in a different area outside of the gaze focus area 262, illustrated by the dashed circle 254, which we from now on will call pointer focus area 254.

The position of the mouse pointer on the screen 210 is detected by a position detection unit 270 which receives mouse movement coordinates when the pointing device 250 moves across the surface it is placed on and translates them into mouse pointer 252 coordinates on the display 210. This information is also fed to the processing unit 280. Now, the processing unit 280 also receives information about the direction and position of the user gaze 260 from the imaging device 230 and calculates the position of a gaze focus area 262 which is a circular shaped area of certain size on the display 210. How to translate the direction and position of the user gaze 260 into the gaze focus area 262 based on the information from a single or multiple imaging devices 232 is known to the skilled person and will not be explained further here. By comparing the position of the gaze focus area 262 and the position of the pointer focus area 252 the processing unit 280 can determine whether the pointer focus area 252 is contained within the gaze focus area 262. It may be possible for the user to define how large a pointer focus area 252 should occupy. Also, the user may be allowed to specify whether the pointer focus area 252 should be entirely contained in the gaze focus area 262 for the tooltip to be shown or whether a partial overlap between the two area should be sufficient for the event to be shown. One criterion for the event to be shown to the user may be that as long as there is an overlap between the gaze focus area 262 and the pointer focus area 252, the event should be shown to the user. Moreover, since the event may not appear instantly when pointing with a mouse pointer on or over it, the electronic device 200 may be set up so that the event is shown when the pointer focus area 252 is entirely contained withing the gaze focus area 262 for a time period, which may be great or equal then 1 second up two 5 seconds. This time period may also be user-defined. It should be mentioned here that the pointer focus area 252 is usually smaller than the gaze focus area 262, because the user gaze, even if focused or a specific part of the display naturally covers a larger area on the display 210 and thus the GUI 220.

In the situation displayed in FIG. 2A, the pointing device 250 is pointing at a screen element 222 via the mouse pointer 252 of the GUI 220 for which an event is available. However, the mouse pointer 252 is located at a position a distance away from the gaze focus area 26, such that the pointer focus area 254 is not contained in the gaze focus area 262 nor overlaps with the gaze focus area 262.

Since this is the case, no event associated with the screen element 222 will be shown according to the present solution. One advantage of the present solution is that the user is not distracted by events he or she is not interested in and not looking at. Rather, in this case, the user gaze focus 262 is focused on a picture displayed in the windows of the GUI 220. In more general terms, whatever information on the GUI 220 the user is interested in, as long as the gaze focus area 262 does not contain the pointer focus area 254 no event will be shown to the user. This is especially advantageous browsing through a web page on the Internet, which, for example, may be a social media page which usually has a large number of posts and where a lot of screen elements 122 have events associated with them in the form of tooltip information, animated sequences or video clips played from a still image, where in a usual situation the user uses a mouse wheel to scroll through the page, but generally does not move the mouse itself. In such a scenario, events would be shown more or less regularly thus distracting the user from what he or she is interested in reading. It is well known that screen elements that are moving or changing appearance draw the attention of the user away from the web page content that he or she is currently reading or consuming.

It should also be mentioned here that the pointing device 250 in this embodiment of the solution, besides being a mouse, which may be wired or wireless, also may be a user finger (292) and the display 210 be a touch-sensitive display. In this case, the mouse pointer 252 may or may not be visible on the display 220 and the user finger would be functioning as a pointing device 250 as well, alone or in parallel with the mouse. In this case, the position of the user finger as an additional pointing device 250 may be determined by means of a touch controller 290 which would register the coordinates of the user finger 292 on the touch-sensitive display 210 and feed them to the processing unit 280.

FIG. 2B displays the embodiment of an electronic device 200 according to the present solution in a second situation.

In this scenario, the imaging device 230 will detect that the user has moved his or her gaze 260 away from the screen element Pictures 252 and is instead looking at the screen element Video, so that the gaze focus area 262 now has shifted to the area 262 shown in FIG. 2B. Also, the position sensing circuitry 270 will have detected that the user has moved the pointing device 250 to the new position on the display 210 corresponding to the new position of the mouse pointer. This new position is shown by the encircled dotted pointer focus area 252. By comparing the coordinates of the pointer focus area 252 with the coordinates of the gaze focus area 264 the processing unit 280 will detect that the pointer focus area 252 is entirely contained with the gaze focus area 262 as is apparent from FIG. 2B. Since the user is thus both looking and pointing with the mouse pointer at the same area of the GUI 210, this is a signal that the user is interested in seeing the event associated with the screen element Video. Since the screen element is a link to a video clip, the event that is associated with that screen element is a video clip with or without sound, an animated sequence or tooltip information. In this case the processing unit 280 will instruct the GUI 210 to show the event in the presently visible window in the GUI 210 which may be to start playing a video clip corresponding to the screen element, an animated sequence or tooltip information associated with the screen element Video.

As already mentioned in FIG. 2A, this would also function analogously when the user is using his or her finger to point to the screen element Video on the GUI 210 and looking at the same screen element.

Moreover, an event associated with the screen element Video may also be shown to the user when the gaze focus area 264 and the pointer focus area 252 overlap, i.e. when the pointer focus area is not entirely contained within the gaze focus area 264, i.e. when they overlap.

This would include the case when the circles depicting the pointer focus area 252 and the gaze focus area 264 only touch each other.

All possible alternatives mentioned, i.e. pointer focus area 254 entirely contained within the gaze focus area 264 and/or pointer focus area 254 overlapping with the gaze focus area 264 (including these two areas only touching each other) and showing of associated to the user may be dependent on the time period the user gaze is focused on the specific screen element, which may be equal or greater than a threshold, such between 1-5 seconds. This threshold may also be user defined.

Thus, if during that time period the pointer focus area 252 is entirely contained withing the gaze focus area 264, the event associated with the specific screen element will be shown to the user, otherwise not.

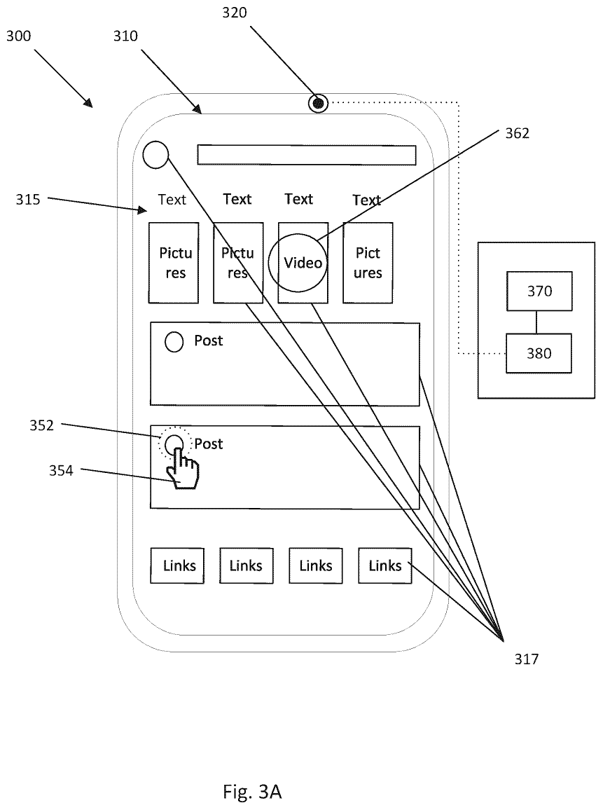

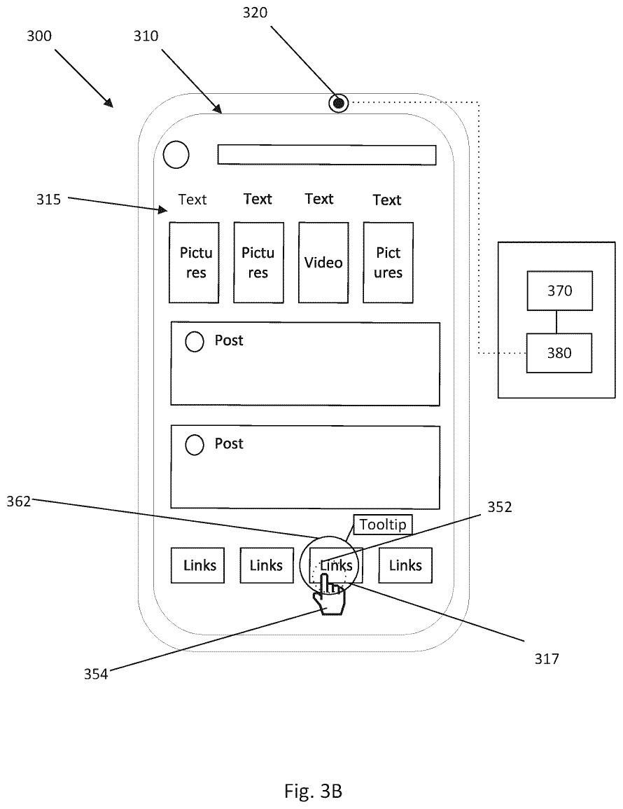

FIG. 3A depicts a second embodiment of an electronic device 300 according to the present solution in a first mode. In this case the electronic device 300 is a smartphone or a tablet with a touch-sensitive display 310. The touch-sensitive display 310 may be of any known type, such as capacitive, inductive, resistive or acoustic-wave based. It is connected to a touch controller 370 which registers the presence and position of a user finger 354 on or in the case of a capacitive touch-sensitive display 310 even above the surface of the touch-sensitive display 310. The touch-sensitive display 310 in FIG. 3A is displaying a GUI 315 which in this example embodiment is showing a web page like the one in FIGS. 1-2B but adjusted to the smaller display size of the electronic device 300, which in this example is a smart phone or a tablet. The web page displays several screen elements 317, which may be text fields with hyperlinks, such as the ones towards the bottom of the display GUI 315, text posts by different users, picture or video fields or user profile pictures, where each one of them is associated with an event, such as a tooltip text, an animated sequence or in the case of the video screen element, also with a video clip with or without sound. The electronic device 300 also comprises an imaging device 320, such as a camera which may be a single camera or contain multiple cameras. Besides the usual functions of the imaging device 320, such as taking of photographs, especially of the user holding the electronic device 300, the imaging device 320 is also configured to supply information to a processing unit 380 about the direction of the user gaze (not shown) towards the display 310 and the position of the user gaze in relation to the display 310. The processing unit 380 is then from this information able to calculate the position of the gaze focus area on the display 310 and thus also on the GUI 315.

In this first scenario, the processing unit 380 has determined that the user (not shown) gaze focus area 362 shown as a solid line circle is located on the screen element video.

However, the user finger 354 in this example embodiment is hovering over the display 310 above the screen element 317 named “Post” and specifically over the solid circle in the field “Post”, which is meant to symbolize the user profile image of the user who has created the text in the “Post” field. The processing unit, having calculated the positions of the pointer focus area 352 (seen as a dashed circle) and the gaze focus area 362 (seen as a solid circle) on the GUI 315 will, after a comparison of their coordinates on the display 310 detect that they neither overlap nor that the pointer focus area 352 is contained in the gaze focus area 362. Thus, the processing unit 380 will neither instruct the GUI 315 to show an event in the form of a tooltip information associated with the screen element 317 “Video” nor will it instruct the GUI 315 to shown an event in the form of playing the video clip associated with the same screen element 317.

Since it is not clear whether the user is interested in seeing the event in the form of a tooltip information associated with the screen element 317 carrying the name “Post” or whether he or she would rather see and event in the form of a tooltip information associated with the screen element 317 called “Video” or whether he or she would like to see an event in the form of a video clip associated with the latter screen element 317, no event associated screen element 317 will be shown. This means in practice that event in the form of tooltip information will be displayed and/or no video clip will be played for screen element 317. Alternatively, events associated with screen elements 317 linking to a video clip may be shown as video clips as soon as the gaze focus area 362 is detected by the processing unit 380 to be on the corresponding screen element 317. On the other hand, events, such as tooltip information associated with another screen element 317 where the pointer focus area 352 is outside of the gaze focus area 362, will not be shown.

Both alternatives may be dependent on the time period the user gaze is focused on one specific screen element 317, which may equal to or above a time threshold, which as an example may be between 1-5 seconds. This threshold may also be user defined.

Thus, if during that time period the pointer focus area 352 is entirely contained withing the gaze focus area 352, the event associated with the specific screen element 317 will be shown to the user, otherwise not.

FIG. 3B depicts a second embodiment of an electronic device 300 according to the present solution in a second mode. In this case, processing unit 380 has received information from the imaging device 320 about the direction and position of the user gaze in relation to the display 310 and calculated the corresponding position of the gaze focus area 352 on the GUI 315. In this example, the processing unit 380 has detected that the position of the gaze focus area is overlapping with the screen element 317 with the name “Links” which is a hyperlink to another location on the web page. Moreover, the processing unit 380 has received information from the touch controller 370 about the position of the user finger 354 on or above the display 310 and calculated the corresponding position of the finger focus area 352 on the GUI 315. In this example, the location of the finger focus area 352 is also detected to be overlapping with the position of the screen element 317 called “Links”. Since through a comparison of the position of the gaze focus area 362 and the pointing focus area 352 the processing unit 380 has detected that the pointing focus area 352 is located entirely within the gaze focus area 362, it will instruct the GUI 315 to show an event associated with the screen element 317 “Links”, which in this case will be tooltip information about the link. In concrete terms, the tooltip information will be the address to the hyperlink associated with the screen element 317 as shown in FIG. 3B.

As mentioned in the description of the embodiment in FIG. 3A, an event may be shown when the pointer focus area 352 is entirely contained within the gaze focus area 362 during a time period, where the time period is a threshold greater than or equal to, for example 1-5 seconds or during a user defined period of time. Moreover, an event may be shown in the case when there is an overlap between the two focus areas 352, 362, but where the pointer focus area 352 is not entirely contained within the gaze focus area 362. The upper limit for showing an event for a screen element 317 may be set to the scenario in which the two focus areas do not overlap anymore.

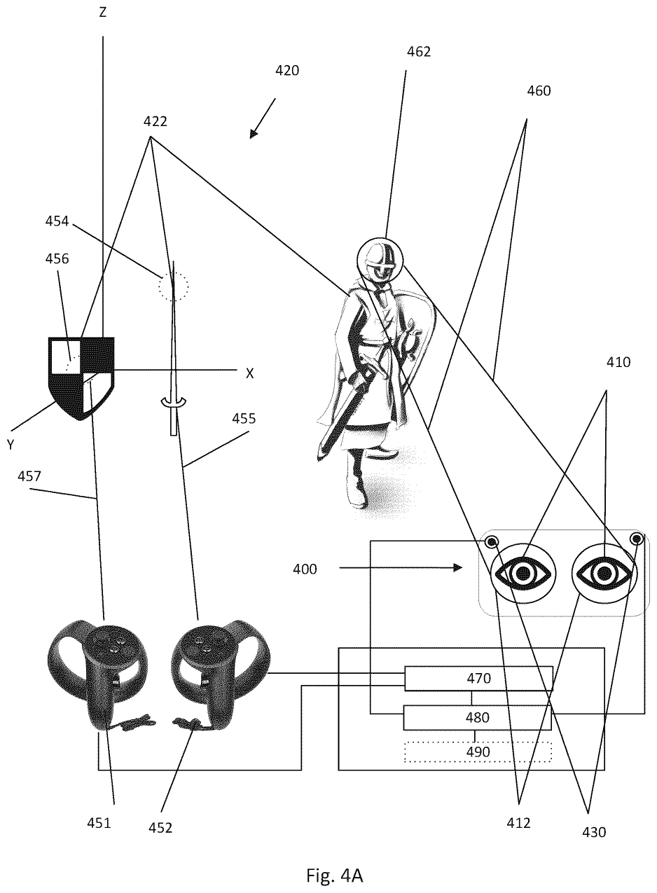

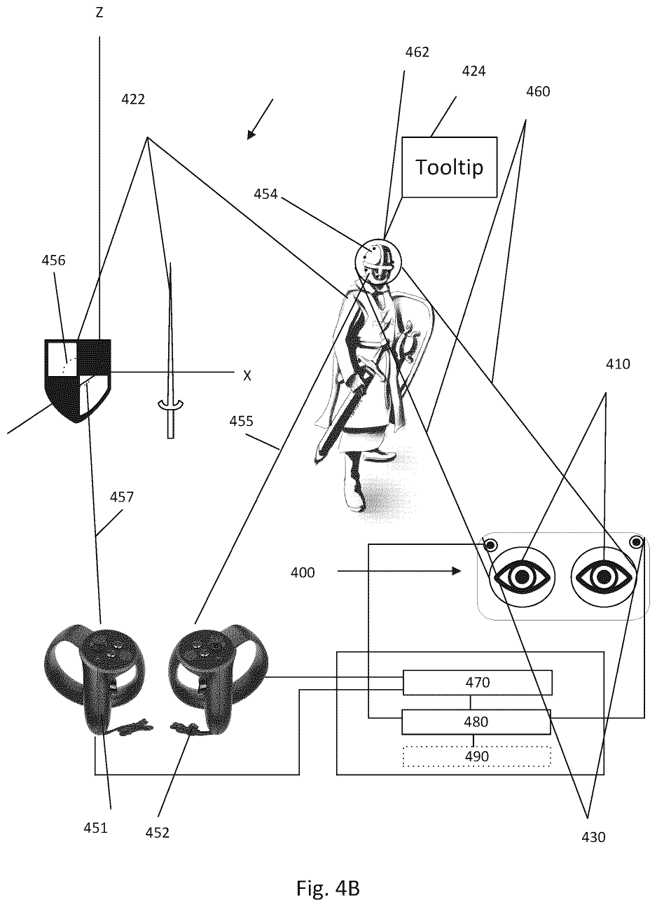

FIG. 4A depicts a third embodiment of an electronic device 400 according to the present solution in a first mode. As can be seen from FIG. 4A an electronic device 400 in the form of a Virtual Reality (VR) headset is shown having at least two lenses 412 which function as two displays 412 for the VR headset, each showing a slightly shifted version of a VR GUI 420 for each use eye 410 in order to achieve a stereoscopic or three-dimensional effect. In order to track the position of the electronic device 400 in 3D space an imaging device 430, which in this embodiment is realized as two cameras, is used. The imaging device 430 also serves to track the direction and position of the user gaze 460 in the VR GUI 415.

Beside the electronic device 400, two hand controls 451, 452 are displayed, one for each user hand, which the user can utilize to point, select, and manipulate different screen elements 422 in the VR GUI 420, i.e., the shield, the sword and the knight. A position sensing circuitry 470 in the electronic device 400 receives coordination and movement data from the left-and right-hand controls 451, 452 through for example inertial sensors in the controls and sends the data to a processing unit 480 in the electronic device 400 which then translates the data received into position data in the VR GUI 420 and instructs the VR GUI 420 to display the position of the left-and right-hand controllers 451, 452 in the VR GUI 420.

Now, in this embodiment, the processing unit 480 has detected that the user is pointing at the screen element shield 422 with the left-hand control 451 and at the screen element 422 sword with the right-hand control. The pointer focus areas 454 and 456 in the form of dashed circles are meant to demonstrate the pointing focus of the user in the VR GUI 420.

However, the imaging device 410 in the form of two cameras 410 oriented away from the electronic device 400 and toward the outer environment of the electronic device 400 has detected the direction and position of the gaze in the 3D-space (i.e., the real physical space around the user wearing the electronic device 400) which is then sent to the processing unit 480, which from this information calculates the gaze focus area 462 marked by the solid circle in the VR GUI 420. It appears that the user instead of focusing his or her gaze on the screen elements 422 shield and sword, is focusing on the screen element 422 knight.

Usually in already existing VR GUI solutions on the market, a tooltip-or tooltip-like information is displayed whenever the user uses one hand control 451, 452 to point at a selectable object in the VR GUI. In the embodiment of the present solution in FIG. 4A, the gaze focus area 462 is centered around the head of the screen element 422 knight and not on shield and sword. Since the pointer focus areas 454 and 456 are not contained in the gaze focus area 462, no event 462 will be shown for the screen elements 422 shield and sword, which would be tooltip information or an animation for these screen elements 422.

FIG. 4B depicts a third embodiment of an electronic device according to the present solution in a second mode. In this second mode, the user eyes are detected by means of the imaging device 430 and the processing unit 480 to be directed towards the screen element 422 knight or rather the head of the knight marked by the gaze focus area 462 marked as the solid circle. At the same time, the user is detected by the positioning sensing circuitry 470 and the processing unit 480 to be pointing the right hand control 452 towards the same screen element 422 knight which his or her eyes are focused on. Thus, the pointer focus area 454 marked as a dashed circle is detected by the position sensing circuitry 470 and the processing unit 480 to be also around the knight's head. Now, comparing the position of the pointer focus area 454 with the gaze focus area 462, the processing unit 480 may determine that the pointer focus area 454 is contained within the gaze focus area 462. This will mean that there is an active interest by the user of the electronic device 400 in receiving more information about the screen element 422 knight. Consequently, the processing unit 480 will instruct the VR GUI 420 to shown an event associated with the screen element 422 knight, which may be tooltip information showing explanatory or additional information about the screen element 422 knight. The processing unit 480 may also instruct the VR GUI 420 to show an event in the form of an animation of the screen element 422 knight as well. In this fashion, only for screen elements 422 which the user is actively interested in the VR GUI 422 will there be displayed an event associated with that screen element. Also, worth pointing out, like in the embodiments of the present solution shown in FIGS. 2A-2B and 3A, 3B, the processing unit 480 may determine that the pointer focus area 454 is not entirely contained within the gaze focus area 462, but that they overlap. This would include the scenario when the pointer focus area 454 and the gaze focus area 462 touch each other. This could also be a viable criterion for the processing unit 480 to still instruct the VR GUI 420 to show an event 424, such as tooltip information related to the screen element 422 knight, since it is very likely that the user is interested in that event 424. The limiting criterion for the processing unit 480 whether or not to instruct the VR GUI 420 to show the event 424 for the screen element 422 could be whether there is any overlap between the two focus areas. If there is no overlap between them, the processing unit 480 will not instruct the VR GUI 420 to show the event 424. Also, the processing unit may compare the time period during which the pointer focus area 454 is contained or overlapping with the gaze focus area 462 and decide if the two focus areas are contained within each other long enough, so that the user is not accidentally looking at the screen element 422 and accidentally pointing at the screen element 422 with one of the left-or right-hand controls 451, 452. This time period may be exceeding a threshold, which could be great or equal to 1 to 5 seconds or be defined by the user.

The VR GUI in the present case is an extremely simplified version of an already existing VR GUI. Usually there is a much higher number or screen elements 422 in actual VR GUIs and it would be very distracting for the user to see events associated with each and one of them as soon as the user is accidentally directing his or her hand controls 451, 452 towards these screen elements, even though he or she has no active interest in them. The present solution will display an event 424 associated with a screen element 422 in the VR GUI 420 when the user is actively interested in the screen element 422 and minimize distractions to the user.

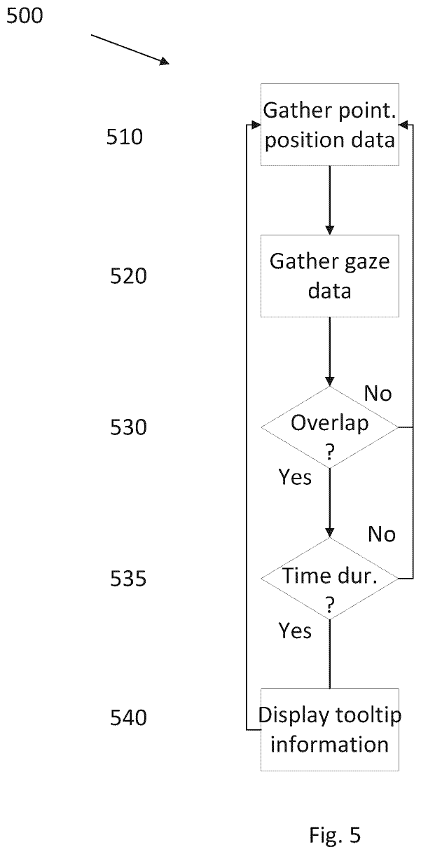

FIG. 5 displays an embodiment of a method 500 according to the present solution. The embodiment of the method 500 according to the present solution is adapted to be implemented by any of the embodiments of the electronic device according to FIGS. 2A-4B.
At step 510, a position sensing circuitry gathers positioning data for a pointing device on or above a user interface displayed by an electronic device, such as the GUIs depicted in FIGS. 2A-4B. These may be, depending on the specific embodiment of the electronic device, a display, a touch-sensitive display or a display of a VR GUI in a VR headset. This information is sent to a processing unit, such as the processing units depicted in FIGS. 2A-4B.
At step 520, information about the direction and position of a user gaze is gathered by an imaging device, such as a single or multiple cameras or an eye-tracking device and fed to a processing unit, i.e., the same processing unit as mentioned in the previous sentence.
At step 530 the processing unit translates the positioning data to a position on the display or in a VR environment, such as shown in FIGS. 2A-4B in the form of a pointer focus area. Also, at the same step 530, the processing unit translates the data related to the user gaze to a gaze focus area on the display or in the VR environment. The processing unit at step 540 compares the position of the pointer focus are with the position of the gaze focus are on the display or the VR environment and decides whether the pointer focus is contained with the gaze focus area or if they overlap.

If the two focus areas are not contained within each other or overlap, the processing unit returns to step 510 to continue gathering pointer position data and user gaze data. This means that the user is not interested in the screen element that he is accidentally pointing at.

However, if the processing unit at step 530 detects that there is contained or overlap between the two focus areas it checks at step 535 whether the containment or overlap are happening withing a time period exceeding a threshold, such as 1 to 5 seconds or some other user-defined threshold.

If this time period is shorter than the threshold, the processing unit judges that to be an accidental containment and overlap and returns to the position data gathering steps 510 and user gaze data gathering steps 520.

However, if the time period for the containment or overlap between the two area is sufficiently long, i.e., equal or higher that the threshold, the processing unit judges this to be a sign of user interest in the screen element where the two focus areas are contained or overlapping and instructs the GUI or VR GUI to shown an event associated with the screen element at step 540, which may be tooltip information, an animated sequence, a video clip with and/or without sound.

Now, it should be mentioned that steps 510 and 520 are usually performed simultaneously and continuously and the sequential order of these steps is simply for illustration purposes. Also, the processing unit may be gathering new pointer position data and user gaze data while determining the overlap and the time duration, so that it may quickly adapt to the dynamically changing environment when the user is moving a pointing device and his gaze over the display or the VR environment.

1: An electronic device comprising:
a display for displaying a user interface;
an imaging device for determining an area of focus of a user gaze on the display;
position sensing circuitry for determining the position of a pointing device on or above the user interface displayed;
a processing unit; and
computation circuitry configured to compare the position of the pointing device on or above an element of the user interface with an area of focus of the user gaze determined by the imaging device and to instruct the display to show an event associated with the element when the position of the pointing device determined falls within the area of focus of the user gaze.

2: The electronic device according to claim 1, wherein the processing unit is configured to instruct the display to show an event associated with the element when the position of the pointing device determined falls entirely within the area of focus of the user.

3: The electronic device of claim 1, wherein the area of focus comprises an area of the display at which the user gaze is focused for an amount of time exceeding a threshold value.

4: The electronic device of claim 1, wherein the position of the pointing device on or above an element of the user interface is a stationary position.

5: The electronic device of claim 1, wherein the event associated with the element is a tooltip information.

6: The electronic device of claim 1, wherein the event associated with an element is an animated sequence, a video clip and/or a sound clip.

7: The electronic device of claim 1, further comprising a memory for storing the position of the pointing device determined by the position sensing circuitry.

8: The electronic device of claim 1, wherein the display comprises one of Thin Film Transistor (TFT), Liquid Crystal Display (LCD), Light Emitting Diode (LED), Organic Light Emitting Diode (OLED), or Active Matrix Organic Light Emitting Diode (AMOLED) displays.

9: The electronic device of claim 1, wherein the display is a touch-sensitive screen and the position sensing circuitry comprises a touch-sensitive screen controller.

10: The electronic device of claim 1, wherein the display is a projection surface pertaining to a set of Virtual Reality (VR) or Augmented Reality (AR) glasses.

11: The electronic device of claim 10, wherein the position determined by the position sensing circuitry is located in a virtual coordinate system in a VR or AR environment.

12: The electronic device of claim 1, wherein the position sensing circuitry is integrated in the processing unit.

13: The electronic device of claim 1, wherein the position sensing circuitry comprises a computer mouse or trackball tracking system.

14: The electronic device of claim 1, wherein, wherein the imaging device comprises one or more cameras.

15: The electronic device of claim 1, wherein the imaging device comprises a gaze tracking system.

16: The electronic device of claim 1, wherein the electronic device is a communication device.

17: The electronic device of claim 1, wherein the communication device is wireless communication device for a cellular communications system.

18: A method for showing an event on a display for a user interface, comprising:
determining the position of a pointing device on or above the display;
determining an area of focus of a user gaze on the display;
comparing the position of the pointing device with the area of focus of the user gaze; and
showing an event associated with an element of the user interface displayed when the position of the pointing device detected falls within the area of focus of the user gaze.

19. (canceled)

20: A non-transitory computer readable medium having stored therein computer program code for performing a method when said computer program code is executed by a programmable processing unit of an electronic device, wherein the method is for showing an event on a display for a user interface, and comprises:
determining the position of a pointing device on or above the display;
determining an area of focus of a user gaze on the display;
comparing the position of the pointing device with the area of focus of the user gaze; and
showing an event associated with an element of the user interface displayed when the position of the pointing device detected falls within the area of focus of the user gaze.
